(19) United States
(12) Patent Application Publication
(10) Pub. No.: US 2020/0019353 A1
(43) Pub. Date: Jan. 16, 2020

(54) IMAGE INSPECTION SYSTEM, IMAGE INSPECTION METHOD, NON-TRANSITORY COMPUTER-READABLE RECORDING MEDIUM STORING IMAGE INSPECTION PROGRAM

(71) Applicant: Konica Minolta, Inc., Tokyo (JP)

(72) Inventor: Ryousuke OKAJIMA, Tokyo (JP)

(73) Assignee: Konica Minolta, Inc., Chiyoda-ku, Tokyo (JP)

(21) Appl. No.: 16/504,997

(22) Filed: Jul. 8, 2019

(30) Foreign Application Priority Data
Jul. 10, 2018 (JP) 2018-130540

(51) Int. Cl. G06F 3/12; H04N 1/00

(52) U.S. Cl. CPC G06F 3/1208; G06F 3/1256; H04N 1/00681; G06F 3/1204; G06F 3/1257

(57) ABSTRACT

An image inspection system includes: an image former that forms an image on a sheet based on image data including a common area and a variable area set therein, wherein a same image is to be printed in the common area on multiple print pages, and a variable image that differs between the multiple print pages is to be printed in the variable area; an image reader that generates a read image by reading the formed image; a hardware processor that generates an inspection image used to perform image inspection, based on a first read image generated; and a hardware processor that inspects a second read image generated, based on a difference between the second read image and the inspection image, excluding the area designated by a user as an exception to inspection.

### CROSS REFERENCE TO RELATED APPLICATIONS

The entire disclosure of Japanese Patent Application No. 2018-130540 filed on Jul. 10, 2018 is incorporated herein by reference in its entirety.

### BACKGROUND

### Technological Field

The present invention relates to an image inspection system, an image inspection method, and a non-transitory computer-readable recording medium storing an image inspection program.

### Description of Related Art

There has been apparatuses or systems in which an electrophotographic image forming apparatus (a copier, a printer, a facsimile machine, or multifunctional peripherals for them) that forms toner images on sheets, and an output image reading apparatus including a scanner and the like are connected inline or in an integrated manner. Here, the output image reading apparatus functions as a postprocessing apparatus that reads the output from the image forming apparatus (that is, images on sheets; the same applies hereinafter) through a scanner and the like, feedbacks information on colors or misalignments to the image forming apparatus, and corrects images.

In recent years, in addition to systems constituted of an image forming apparatus and an output image reading apparatus, there have been proposed systems including an inlined or integrated quality inspection apparatus (also referred to as automated quality check apparatus) that automatically inspects the quality of the output from the image forming apparatus (see, for example, Japanese Patent Application Laid-Open No. 2011-248577 (hereinafter referred to as PTL 1)).

This quality inspection apparatus executes a quality check job based on data for inspection (inspection image data) and performs inspection (quality check) of the quality of the output. Here, reference data as a reference or a correct image, and image data of the output that has been actually printed (read image data given by output image reading apparatus) are used as inspection image data. In particular, upon execution of a quality check job, the quality inspection apparatus acquires input image data, which is input to the image forming apparatus, as reference data, and acquires image information (read image data) of the output read by the output image reading apparatus. In addition, the quality inspection apparatus compares the acquired read image data with the corresponding reference data to inspect a failure/no-failure in the quality of the image printed on the sheet (that is, presence/absence of a defective image). With this system (hereinafter referred to as image quality inspection system), whether or not the output from the image forming apparatus (the image on the sheet) is printed with the quality required by the customer can be automatically inspected (quality-checked).

The following method is known as a method of creating correct data (an inspection image) in the case where multiple copies are printed for such quality check. In other words, in printing multiple copies, print of only one copy is executed and the sheet printed out this time is scanned and the image data is saved. The user visually checks the print output result and, if there is no problem, the saved image data is used as correct data (an inspection image) for the second or later copies.

By the way, in the case of an image containing variable data such as the address and name of the destination, as in the case of printing multiple copies of direct mail, the print contents are different for each page, and the number of print sheets tends to increase. For this reason, when variable data is included in the input image data, to register correct data by the above method, it is necessary to print in advance the number of sheets equal to that of destinations in order to create correct data; thus, the problem arises that the man-hour count and cost increase.

A system using a raster image processor (RIP) image data before printing as correct data is known as a method of creating a correct image used when printing input image data including such variable data. Further, in the technique described in PTL 1, an image read as a correct image and an RIP image before printing are combined to identify a variable data portion, thereby obtaining a correct image.

However, creating correct data using the RIP image before printing as described above has a problem in that a deviation from the acceptable level required by the user is likely to occur as described below. In particular, an RIP image is a complete image that does not include noise or the like, although the user visually judge the actual printed material which contains printing characteristics, noise, and the like specific to the printer. For this reason, the problem arises that, even for a printed material that can be visually judged to have a sufficiently high quality, quality check tends to determine that an image failure has occurred, by simple comparison between an inspection target image that has been actually printed and scanned and the correct image based on the RIP image.

### SUMMARY

An object of the present invention is to provide an image inspection system, an image inspection method, and a non-transitory computer-readable recording medium storing an image inspection program, which are capable of image quality inspection and in which the number of correct images to be created is reduced and a deviation from the acceptable level required by the user is suppressed in printing an image consisting of a variable image portion and a common image portion on multiple pages.

To achieve at least one of the abovementioned objects, according to an aspect of the present invention, an image inspection system reflecting one aspect of the present invention comprises:

an image former that forms an image on a sheet based on image data in which a common area and a variable area set therein, the common area being an area in which a same image is printed on a plurality of print pages, the variable area being an area in which a variable image that differs between the plurality of print pages is printed;

an image reader that generates a read image by reading the formed image;

a hardware processor that generates an inspection image used to perform image inspection, based on a first read image generated; and a hardware processor that inspects a second read image generated, based on a difference between the second read image generated and the inspection image, excluding an area designated by a user as an exception to inspection.

To achieve at least one of the abovementioned objects, according to an aspect of the present invention, an image inspection method reflecting one aspect of the present invention comprises:

forming an image on a sheet based on image data including a common area and a variable area set therein, the common area being an area in which a same image is printed on a plurality of print pages, the variable area being an area in which a variable image that differs between the plurality of print pages is printed;

generating a read image by reading the formed image;

generating an inspection image used to perform image inspection, based on a first read image generated; and

inspecting a second read image generated, based on a difference between the second read image generated and the inspection image, excluding the area designated by a user as an exception to inspection.

To achieve at least one of the abovementioned objects, according to an aspect of the present invention, a non-transitory computer-readable recording medium reflecting one aspect of the present invention is a medium that stores an image inspection program, the program causing a computer to perform processing comprising:

forming an image on a sheet based on image data including a common area and a variable area set therein, the common area being an area in which a same image is printed on a plurality of print pages, the variable area being an area in which a variable image that differs between the plurality of print pages is printed;

generating a read image by reading the formed image;

generating an inspection image used to perform image inspection, based on a first read image generated; and

inspecting a second read image generated, based on a difference between the second read image generated and the inspection image, excluding the area designated by a user as an exception to inspection.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing the entire configuration of an image quality inspection system according to this embodiment;

FIG. 2 is a block diagram showing the main part of a control system in the image quality inspection system according to this embodiment;

FIG. 3 is a flowchart for explaining the flow of processing of a quality check job;

FIG. 4 is a diagram schematically showing an example of printing input image data including variable data and common data;

FIG. 5 is a diagram for explaining processing for registering correct data;

FIG. 6 is a flowchart showing the flow of processing for image quality inspection after input image data including variable data and common data is printed;

FIG. 7 is a diagram showing an example of a setting screen for setting an area related to variable data;

FIG. 8 is a diagram showing an example of a screen for setting whether or not an area related to variable data is to be included in an inspection target;

FIG. 9 is a diagram showing an example of a screen displayed on an operation display section to set a “User designated area” related to variable data;

FIGS. 10A, 10B, and 10C are diagrams for explaining an example of printing input image data including variable data (characters and graphics) and common image data;

FIG. 11 is a diagram showing a form in which the character portions and the graphic portions in each page of the variable data shown in FIGS. 10A to 10C are superimposed; and

FIG. 12 is a diagram showing the state where the common variable area (attribute) and individual variable pixel information in the character portions shown in FIGS. 10A to 10C are superimposed.

### DETAILED DESCRIPTION OF EMBODIMENTS

Hereinafter, one or more embodiments of the present invention will be described with reference to the drawings. However, the scope of the invention is not limited to the disclosed embodiments.

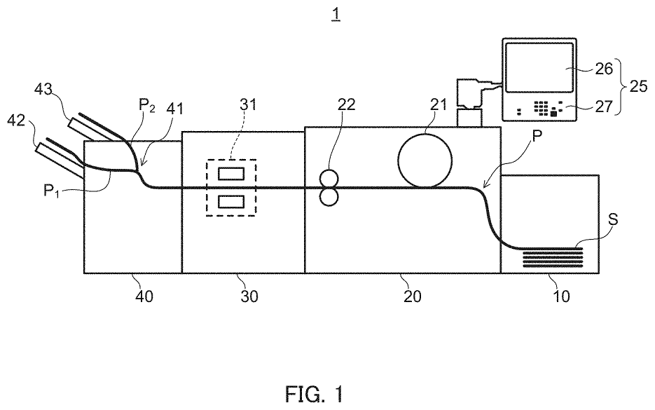

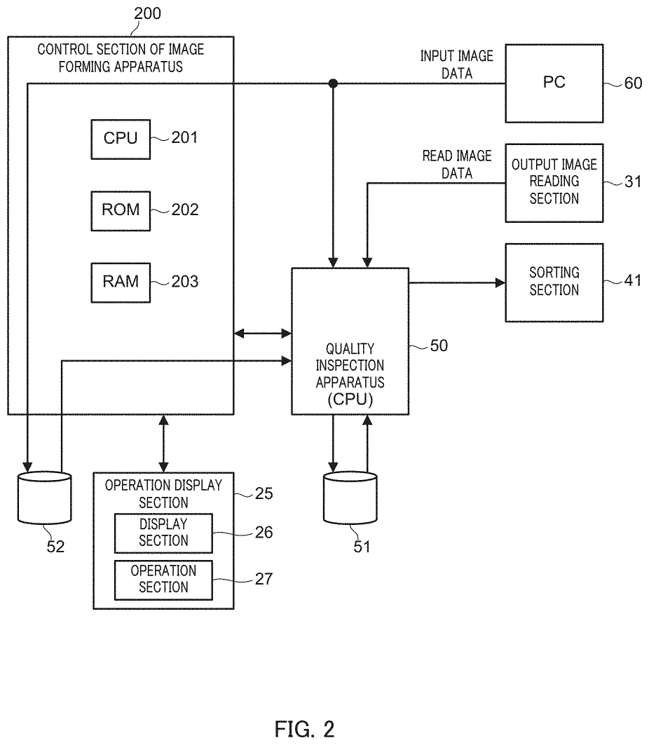

FIG. 1 is a diagram schematically showing the entire configuration of image quality inspection system 1 according to an embodiment of the present invention. FIG. 2 shows the main part of a control system for explaining signal flows and the like between the apparatuses constituting image quality inspection system 1 according to this embodiment.

Image quality inspection system 1 shown in FIGS. 1 and 2 forms (outputs) an image on sheet S through image forming apparatus 20, reads the image on that sheet S, inspects failure/no-failure (presence or absence of abnormal images) in the quality of the output image according to the reading results, and then displays the inspection results, for example.

As shown in FIG. 1, image quality inspection system 1 includes image forming apparatus 20 that forms an image based on input image data on sheet S, sheet feeding apparatus 10 that feeds sheet S to image forming apparatus 20, image reading apparatus 30 that reads the image on sheet S supplied from image forming apparatus 20, and postprocessing apparatus 40 including multiple sheet trays (42, 43).

In image quality inspection system 1, sheet feeding apparatus 10, image forming apparatus 20, image reading apparatus 30, and postprocessing apparatus 40 are physically connected in the order presented from the upstream side of the sheet S conveying direction (apparatus bodies are coupled to one another), and conveyance path P for sheet S lies between these apparatus. This conveyance path P is branched by sorting section 41 of postprocessing apparatus 40 to path P₁ connected to lower sheet tray 42 and path P₂ connected to upper sheet tray 43.

Although conveyance path P in image forming apparatus 20 is indicated by a single line for simplicity in FIG. 1, a double-sided transfer path for double-sided printing is provided in actual image forming apparatus 20. In addition, although there are two branch paths P₁ and P₂ in postprocessing apparatus 40 for simplicity in FIG. 1, more branch paths may be provided depending on the number of sheet trays.

Sheet feeding apparatus 10 can contain various sizes or types of sheets S. Sheet feeding apparatus 10 includes a sheet feeding roller for feeding contained (stacked) sheets S one by one, a motor for driving the sheet feeding roller, and the like.

Image forming apparatus 20 includes intermediate transfer type image formation section 21 using electrophotographic process technology. In this example, image formation section 21 primary-transfers toner images of yellow (Y), magenta (M), cyan (C), and black (K) formed on a photoconductor drum, which is not shown in the drawings, on an intermediate transfer belt (not shown in the drawings), superimposes the toner images of the four colors together on the intermediate transfer belt, and secondary-transfers it to sheet S, thereby forming a toner image. On the downstream side of the sheet S conveying direction in image formation section 21, fixing section 22 is disposed for fixing the toner image on sheet S by heating and pressing the conveyed sheet S with the secondary-transferred toner image. These image formation section 21 and fixing section 22 have well-known configurations and their detailed description will therefore be omitted. The scheme for formation of images in image forming apparatus 20 is not necessarily the above-described scheme and may be any of other various schemes.

Operation display section 25 is provided to the apparatus body of image forming apparatus 20. This operation display section 25 consists of, for example, a liquid crystal display (LCD) with a touch screen, and functions as display section 26 and operation section 27. Display section 26 displays various operating screens, the image state, the operation status of each function, and the like in response to a display control signal input from control section 200, which will be described later. Operation section 27, which includes various operation keys (so-called hardware switches), such as a numeric key pad and a start key, receives various input operations from the user and outputs an operation signal to control section 200. Display section 26 displays various icons (so-called software switches) selectable with a cursor (pointer) or the like on various screens described below, and outputs an operation signal to control section 200 upon reception of various input operations from the user.

As shown in FIG. 2, image forming apparatus 20 includes control section 200 that entirely controls image forming apparatus 20. Control section 200 includes central processing unit (CPU) 201, read only memory (ROM) 202, random access memory (RAM) 203, and the like, and controls the operations of the above-described image formation section 21, fixing section 22, operation display section 25, and sections included in image forming apparatus 20. In particular, CPU 201 of control section 200 reads a program suitable for the content of processing from ROM 202 and expands it to RAM 203, and performs central control on the operations of image formation section 21, fixing section 22, operation display section 25, and the other blocks in image forming apparatus 20 in cooperation with the expanded program.

Examples of the other blocks included in image forming apparatus 20 include an image processing section that performs various types of correction, such as tone correction, on the input image data, a sheet conveying section that drives multiple conveyance rollers that convey sheets S, and a communication section that communicates with external apparatuses via a communication network. Further, image forming apparatus 20 may have the configuration of a copier that copies document images on sheets S, specifically, may include an automated document sheet feeding apparatus, such as an auto document feeder (ADF), and a document image scanning apparatus (scanner). The above-described blocks have well-known configurations and their illustration in the drawings or description will therefore be omitted.

As shown in FIGS. 1 and 2, image reading apparatus 30 includes output image reading section 31 that optically reads the image (toner image) on sheet S discharged from image forming apparatus 20. To be specific, output image reading section 31 optically scans sheet S, causes the reflected light from sheet S to form an image on the light receiving surface of a charge coupled device (CCD) sensor (not shown in the drawings), reads the images on both sides of sheet S, and generates read image data based on the reading results. The read image data generated by output image reading section 31 is input to quality inspection apparatus 50 which will be described later.

As shown in FIGS. 1 and 2, postprocessing apparatus 40 includes a conveyance roller that conveys sheet S the image of which has been read by image reading apparatus 30, multiple sheet trays 42 and 43 that discharge that sheet S, and sorting section 41 that switches the discharge destination (conveying route) of sheet S. Although FIG. 2 illustrates a configuration provided with two sheet trays 42 and 43 for simplicity, the number of sheet trays is arbitrary, and more sheet trays may be provided. Sorting section 41 includes a switching gate that switches the discharge destination (conveying route) of sheet S to either path P₁ or path P₂, a drive source, such as a solenoid, that drives the switching gate, and an interface for transmitting and receiving data to/from image forming apparatus 20 and quality inspection apparatus 50.

As shown in FIG. 2, image quality inspection system 1 includes quality inspection apparatus 50 that inspects a failure/no-failure (presence or absence of abnormal images) in the quality of the output image formed (output) on that sheet S, according to the read image data generated by image reading apparatus 30. This quality inspection apparatus 50 includes a hardware processor, such as a CPU, a ROM, and a data storage section 51, which will be described later, and a job (hereinafter referred to as a quality check job) for inspecting a failure/no-failure (presence or absence of abnormal images) in the quality of the output image is executed when the CPU reads and executes a program stored in the ROM.

In this embodiment, quality inspection apparatus 50 functions as an inspection image generating section that generates correct images (inspection images) used for image inspection, based on a first read image generated by image reading apparatus 30. Further, quality inspection apparatus 50 functions as an image inspection section that inspects the presence or absence of an image failure by comparison between a second read image generated by image reading apparatus 30 and the correct image (inspection image). It should be noted that the details of these functions of quality inspection apparatus 50 will be described later.

Quality inspection apparatus 50 can be physically incorporated in, for example, a casing such as image reading apparatus 30, postprocessing apparatus 40, or even image forming apparatus 20, or may be an apparatus physically independent of these apparatuses. In the example shown in FIG. 2, quality inspection apparatus 50 is the latter, that is, a physically independent apparatus, and is electrically connected to control section 200, which will be described later, or the like of image forming apparatus 20.

Further, as shown in FIG. 2, image quality inspection system 1 includes PC 60 that outputs input image data and data of printing conditions (various user-set values such as the printing method and the number of copies). In the example shown in FIG. 2, PC 60 supplies these data to both image forming apparatus 20 (control section 200) and quality inspection apparatus 50. Alternatively, a relay apparatus may be provided to branch the reference data transmitted from PC 60 into two and transmits them to control section 200 and quality inspection apparatus 50.

In addition, as shown in FIG. 2, image quality inspection system 1 includes data storage sections 51 and 52 for storing various data such as the reference data described above. Among these, data storage section 51 is a part of quality inspection apparatus 50, and is used to temporarily store reference data. In addition, data storage section 51 stores various data related to an abnormal image detected by quality inspection apparatus 50. Meanwhile, data storage section 52 is provided in the main body (casing) of image forming apparatus 20, and is connected to control section 200 and the CPU of quality inspection apparatus 50 via an interface which is not shown in the drawings.

These data storage sections 51 and 52 can be composed of various data storage media such as HDDs and semiconductor memories.

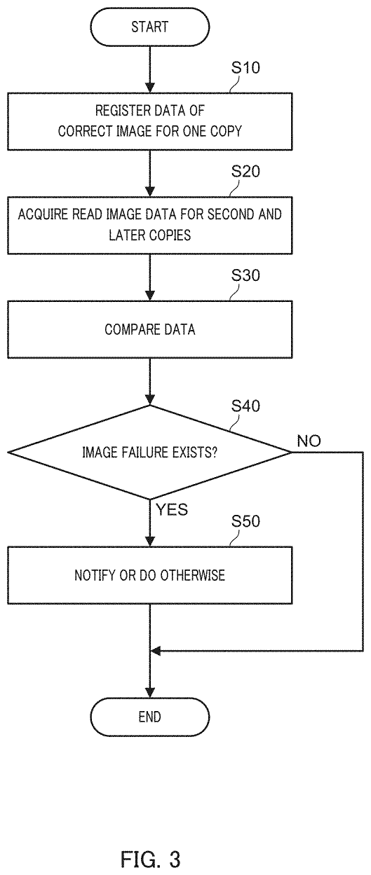

The flow of processing of the quality check job executed by quality inspection apparatus 50 will now be explained with reference to the flowchart of FIG. 3. In this example, it is assumed that multiple copies of a printed material in which multiple pages (for example, three sheets) correspond to one copy is printed and a failure/no-failure in the image on the printed material of multiple copies is inspected.

In Step S10, quality inspection apparatus 50 (the CPU of quality inspection apparatus 50 shown in FIG. 2; the same applies hereinafter) registers, as data of a correct image, one copy of read image data that has been printed by image forming apparatus 20 and read by image reading apparatus 30 when a print job is executed.

To be specific, quality inspection apparatus 50 temporarily stores an image (read image data) in one copy (three sheets of paper in this example) generated by image reading apparatus 30 in a RAM or the like as a candidate for a correct image. In addition, when the image on the actual printed material (for three sheets) is checked and no problem is found by the user, the temporarily stored data is stored in (registered to) data storage section 51 as formal correct image data (hereinafter, also referred to as “correct data”) through an operational input on the correct image registration screen (not shown in the drawings) displayed on display section 26. Afterwards, continuous execution of the print job from the second copy is started by image forming apparatus 20.

In Step S20, quality inspection apparatus 50 acquires read image data that corresponds to the second and later copies (the fourth and later sheets in this example) and has been printed by image forming apparatus 20 and generated by output image reading section 31 of image reading apparatus 30. In one specific example, quality inspection apparatus 50 receives the generated read image data directly from image reading apparatus 30.

In Step S30, quality inspection apparatus 50 inspects the coidentity between the correct image and the read image by comparing the read image data acquired in Step S20 with the data of the corresponding correct image registered in Step S10.

In Step S40, quality inspection apparatus 50 determines whether there is an image failure in the read image data. The processing for this determination differs depending on the item related to the degree of coincidence of the correct image and the read image (type of image failure), the acceptable/non-acceptable reference value (threshold), and the like. These are similar to those in known methods and the detailed explanation of the determination method will therefore be omitted.

Here, when quality inspection apparatus 50 determines that the read image data does not have an image failure (NO in Step S40), the image quality of the printed material is regarded as being acceptable. In this case, quality inspection apparatus 50 notifies postprocessing apparatus 40 to discharge sheet S corresponding to this read image data to the preset first tray (for example, sheet tray 42 in FIG. 1). Subsequently, quality inspection apparatus 50 repeats the processing of Steps S20 to S40 until the print job related to the quality check is completed, and ends the processing upon completion of the print job. In this case, quality inspection apparatus 50 notifies control section 200 of image forming apparatus 20 that, for example, “image quality has been accepted on all the print pages.”

In contrast, when quality inspection apparatus 50 determines that there is an image failure in the read image data (YES in Step S40), the process proceeds to Step S50.

In Step S50, quality inspection apparatus 50 transmits, for example, the message that “an image failure has occurred in the 100th print page” to control section 200 of image forming apparatus 20. At this time, quality inspection apparatus 50 transmits the type of the abnormality, the position of the abnormality in sheet S, and the like together to control section 200 of image forming apparatus 20. In addition, quality inspection apparatus 50 instructs postprocessing apparatus 40 to discharge sheet S corresponding to the read image data having the image failure to the second tray (for example, sheet tray 43 in FIG. 1).

Postprocessing apparatus 40 notified of the presence or absence of an image failure from quality inspection apparatus 50 operates the switching gate of sorting section 41 so that sheet S of interest is discharged to the corresponding sheet tray (42 or 43).

Quality inspection apparatus 50 repeatedly performs the above-described processing of Step S20 to Step S50 until the quality check job is accomplished, transmits the quality check results to image forming apparatus 20 upon completion (accomplishment) of the quality check job, and ends the quality check job.

By the way, when variable data, such as address information (for example, address and name), is included in the input image data as in the case of a direct mail, for example, even if the proportion of the image corresponding to the common portion is high, the image printed by image forming apparatus 20 differs page by page.

In general, print data consisting of a common portion and a variable portion can be created using, for example, a known application (software) installed in PC 60. Formats, such as PPML and PDF-VT, are known as formats of print data including variable data.

For example, in the case of PDF-VT, the PDF file of a common portion and the PDF file of a variable portion exist as separate files. In the PDF file of the common portion, the object number of the PDF file for variable data is described in the portion (area) where the variable data is inserted. Subsequently, in the case of PDF-VT, it is possible to generate a page including variable data by referring to and synthesizing a PDF file for variable data.

A PDF file for variable data and a PDF file for the common portion created by the user are transferred from PC 60 to image forming apparatus 20 through the hot folder function, for example. When rasterizing the PDF file for the common portion, image forming apparatus 20 determines whether the object number of the PDF file for the variable data exists. Here, when the object number of the PDF file for variable data exists, image forming apparatus 20 refers to and rasterizes the PDF object corresponding to the object number from the PDF file for the variable data, combines it with the common portion, and generates image data for one page.

Further, image forming apparatus 20 associates the area where the variable data included in the PDF file for the common portion obtained upon rasterization is located and information on variable data, such as actual variable data, with the pixel of the page data, and saves it as pixel attribute information. Here, examples of the pixel attribute information include individual variable data, data of a common variable area, and data of an object attribute as information of variable data. Here, the individual variable data is data of the image that differs page by page, such as an address or a name in an address book, for example. The data in the common variable area indicates the area for printing each piece of individual variable data on the common area on the sheet. Data of an object attribute indicates the attribute (character, line art, image, or the like) of individual variable data.

Further, image forming apparatus 20 continues the above processing until rasterization of all pages is completed.

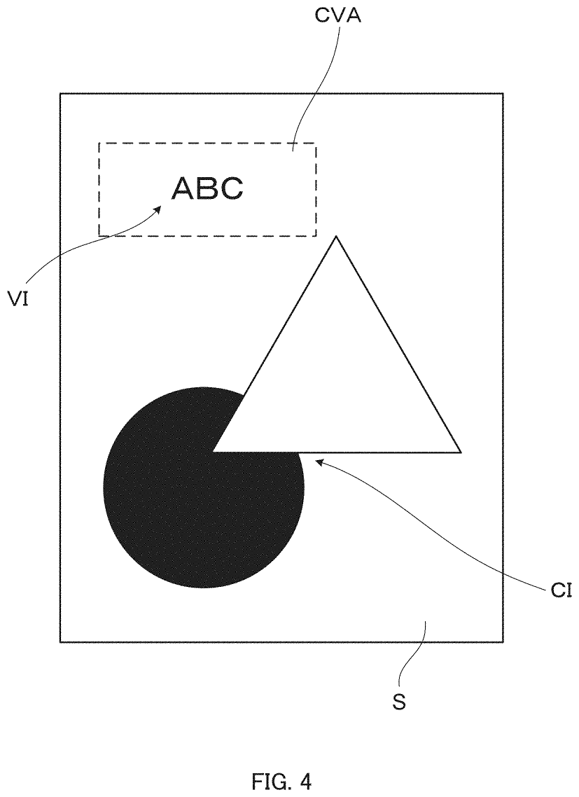

FIG. 4 schematically shows an example of printing input image data including variable data and common data on sheet S. In the example shown in FIG. 4, the black circle and triangle graphic printed on the sheet S are image CI serving as common data, and will hereinafter be referred to as “common image”. On the other hand, area CVA enclosed by the dashed line is an area allocated for printing the image of variable data (indicated by arrow VI). This area CVA is typically common to every page (that is, is provided in the same position and has the same area on sheet S), although the dashed frame is not actually printed. Such an area will hereinafter be referred to as “common variable area”. Image VI printed in common variable area CVA is referred to as “variable image”, and data defining each variable image VI in print data (input image data) is referred to as “individual variable data”.

Although FIG. 4 illustrates the case where variable image VI printed in common variable area CVA is three characters “ABC” for simplicity, in actuality, destination information, such as a name and an address, various identification information, various information such as graphics and photographs, can be printed in common variable area CVA. Further, although FIG. 4 shows the case where “ABC” of variable image VI is printed in common variable area CVA with the center alignment, printing can be done with other various alignment methods such as justified alignment, right alignment, and left alignment. In any case, variable image VI printed in common variable area CVA differs depending on each sheet S on which it is to be printed.

For this reason, in the case where variable data is included in the input image data, with the above-described method, that is, a method in which a part of the image is printed as a test at the time of execution of a print job and is registered as correct data, the man-hour count or cost increases depending on the number of prints (or the number of copies), which is not effective. Typically, printing of a direct mail or the like requires several thousand sheets to be printed at a time. Common image CI (see FIG. 4) is used for printing these several thousand sheets, while variable image VI (address, name, and the like) that differs sheet by sheet (or copy by copy) is printed. In such a case, registration of correct data by the above-described method requires image data of all print pages to be printed and scanned and then registered as correct data, which is not practical.

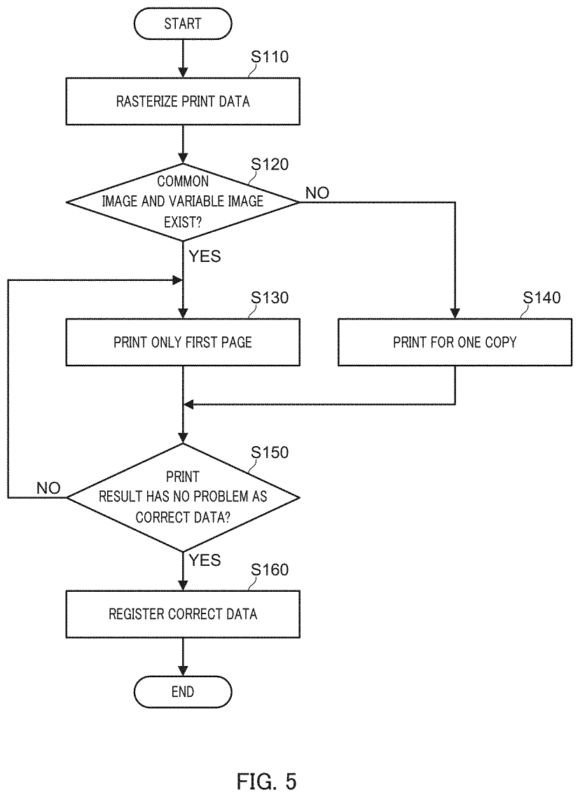

Therefore, in this embodiment, for printing multiple copies or multiple pages, the method of registration of data (correct data) of the correct image in Step S10 is changed between when variable data is included in input image data and when it is not included therein. Hereinafter, the method of registering the correct data will be described with reference to the flowchart of FIG. 5 corresponding to the subroutine of Step S10.

In Step S110, quality inspection apparatus 50 rasterizes print data (input image data, various setting data, and the like) of one copy (for example, three sheets) transmitted from PC 60 for each page (bit map imaging) to generate print data for each page (hereinafter referred to as “page data”). The generated page data is stored in data storage section 51 or the like.

In the subsequent Step S120, quality inspection apparatus 50 determines whether or not the print data (all print pages) for the one copy has both a common image (CI) and a variable image (VI). Here, when quality inspection apparatus 50 determines that it has both a common image and a variable image (YES in Step S120), the process proceeds to Step S130. In contrast, when quality inspection apparatus 50 determines that it does not have a common image or a variable image (NO in Step S120), it is determined that normal printing in which the printed image differs depending on each print page (no common image CI exists) is performed and the process proceeds to Step S140.

In Step S130, quality inspection apparatus 50 sends image forming apparatus 20 and image reading apparatus 30 an instruction to print and image-read (scan) only the first page (one sheet) of the input image data. Afterwards, quality inspection apparatus 50 temporarily stores the image (read image data) of the first page (one sheet) sent from image reading apparatus 30 as a candidate for a correct image, in a RAM or the like, and the process proceeds to Step S150.

Meanwhile, in Step S140, quality inspection apparatus 50 sends image forming apparatus 20 and image reading apparatus 30 an instruction to print and scan one copy (three sheets in this example) of the input image data.

Afterwards, quality inspection apparatus 50 temporarily stores the image (read image data) of one copy (three sheets) sent from image reading apparatus 30 as a candidate for a correct image, in a RAM or the like, and the process proceeds to Step S150.

In Step S150, quality inspection apparatus 50 sends image forming apparatus 20 an instruction to display a correct image registration screen (not shown in the drawings) on display section 26, and determines whether or not the print result has no problem as correct data, according to the content input by the user (the input signal to operation display section 25). At this time, when quality inspection apparatus 50 determines that the print result has a problem as correct data (NO in Step S150), processing for printing, scanning, and temporary storage of the correct image candidate in Step S130 or Step S140 described above is performed again. In contrast, when quality inspection apparatus 50 determines that the print result is not problematic as correct data (YES in Step S150), the process proceeds to Step S160.

In Step S160, quality inspection apparatus 50 stores (registers) the temporarily stored candidate data in data storage section 51 as data of a formal correct image. At this time, quality inspection apparatus 50 creates correct images (inspection images) by the method changed between when each print page includes a common image (CI) and when it does not.

To be specific, in the case of normal printing in which each print page does not include a common image (CI), quality inspection apparatus 50 stores the read image data for one copy (three pages in this example) generated by image reading apparatus 30, in a memory (data storage section 51 or the like; the same applies hereinafter) as it is as a correct image.

In contrast, when each print page includes common image CI and variable image VI, quality inspection apparatus 50 refers to the input image data and creates a correct image (hereinafter referred to as “second correct image” as appropriate) obtained by excluding the above-described variable image VI from the read image data of one page generated by image reading apparatus 30, and stores the second correct image in the memory as an inspection image. The method and mode of generating the second correct image may be different depending on the setting input operation by the user, and the details will be described later.

According to this embodiment that adopts a routine of processing for registration of such correct image data, input image data includes variable data, and when an image including common image CI and variable image VI is printed on multiple pages and inspected, the number of registered correct images can be minimized.

Note that control section 200 of image forming apparatus 20 may mainly perform processing related to the creation of the correct image (the inspection image) described above with reference to FIG. 5.

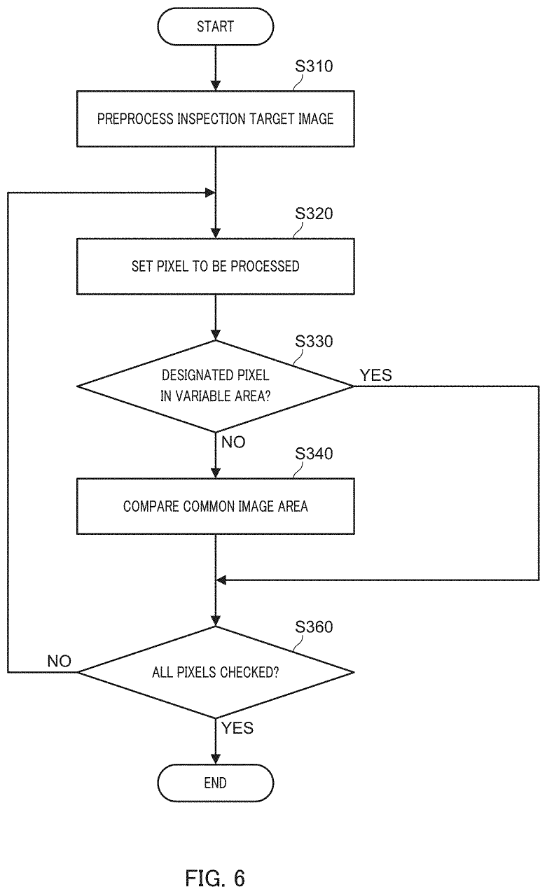

The flow of the processing of the image quality inspection (quality check job) performed when variable data is included in the input image data will now be described with reference to the flowchart of FIG. 6. Note that the series of processing shown in FIG. 6 is quality check processing for the printed material (variable printed material) for one page, and is repeatedly executed for all print pages.

In Step S310, quality inspection apparatus 50 performs preprocessing of an image (read image data) which is an inspection target acquired from image reading apparatus 30. In one specific example, quality inspection apparatus 50 specifies the two-dimensional coordinates of common variable area CVA (that is, sheet S) (see FIG. 4) from the acquired read image data (second read image) of one sheet. In addition, quality inspection apparatus 50 specifies the two-dimensional coordinates (on sheet S) of each pixel constituting the image printed in the area other than common variable area CVA, such as common image CI, based on the read image data.

In the subsequent Step S320, quality inspection apparatus 50 sequentially sets (designates) the pixels to be processed in image quality inspection, according to the coordinates on sheet S, for example.

In Step S330, quality inspection apparatus 50 determines whether or not the designated pixel is a pixel in common variable area CVA. At this time, when quality inspection apparatus 50 determines that the designated pixel is not a pixel in common variable area CVA (NO in Step S330), the pixel is regarded as a part of common image CI, and the process proceeds to Step S340. In contrast, when quality inspection apparatus 50 determines that the designated pixel is a pixel in common variable area CVA (YES in Step S330), the pixel is regarded as variable image VI, and the process skips Step S340 and proceeds to Step S360.

In Step S340, quality inspection apparatus 50 compares the area including the designated pixel with the corresponding area in the correct image (inspection image) to extract a difference, thereby inspecting the quality of the image in the area (presence or absence of a defective image).

In the Subsequent Step S360, quality inspection apparatus 50 determines whether or not the quality inspection (check) of all the pixels other than common variable area CVA is completed. Here, when quality inspection apparatus 50 determines that the check of all the pixels other than common variable area CVA is not completed (NO in Step S360), the process returns to Step S320, and the processing in the above-described Steps S320 to S360. Subsequently, when quality inspection apparatus 50 determines that the check of all the pixels other than common variable area CVA is completed (YES in Step S360), the quality check processing for one page ends.

With the processing described above, the inspection of the presence or absence of the occurrence of an image failure in the area other than common variable area CVA can be executed while preventing a deviation from the acceptable level required by the user.

Quality inspection apparatus 50 can also be configured to inspect the image quality of variable image VI in common variable area CVA, and this case will be described later.

By the way, as shown in FIG. 4, in many cases, common variable area CVA is set to be an area wider than variable image VI. Therefore, when the quality check processing described above with reference to FIG. 6 is performed, in the event of the occurrence of an image failure (such as contamination due to foreign matter; the same applies hereinafter) which is unacceptable in an area (a so-called margin area) such as the periphery of variable image VI in common variable area CVA, the problem arises that such an image failure cannot be inspected.

Further, common variable area CVA may be set to straddle or overlap common image CI in some cases.

For this reason, when the quality check processing described above with reference to FIG. 6 is performed, the problem arises that even in the event of the occurrence of a serious image failure in common image CI in common variable area CVA, such an image failure cannot be inspected.

Therefore, in the above-described quality check job in this embodiment, a part of common variable area CVA (the above-described margin area and the like) can be added to the image quality inspection target.

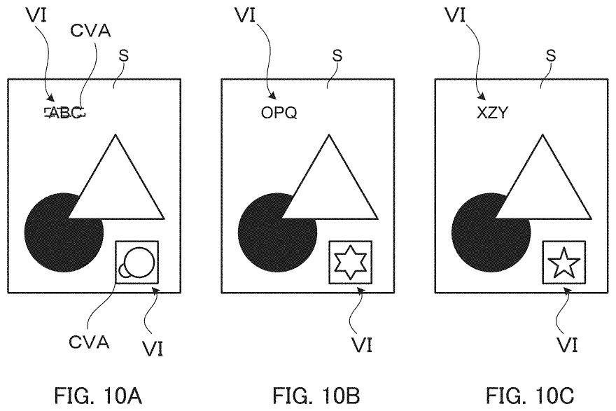

Further, variable image VI may be set to extend out of common variable area CVA (see FIG. 10A and the like). To be specific, in some cases, even if the size of characters to be output in common variable area CVA is set to be large enough to extend out of common variable area CVA or changed (edited) afterwards, it is accepted without causing any error, depending on, for example, the application for editing data such as PDF-VT. Therefore, in the quality check processing described above with reference to FIG. 6, when variable image VI is set to extend out of common variable area CVA, all the extended image (a part of variable image VI) is accidentally detected as an image failure.

Therefore, in this embodiment, prior to the execution of the quality check job described above, the user can arbitrarily set (designate) an area which is not the target of the image quality inspection.

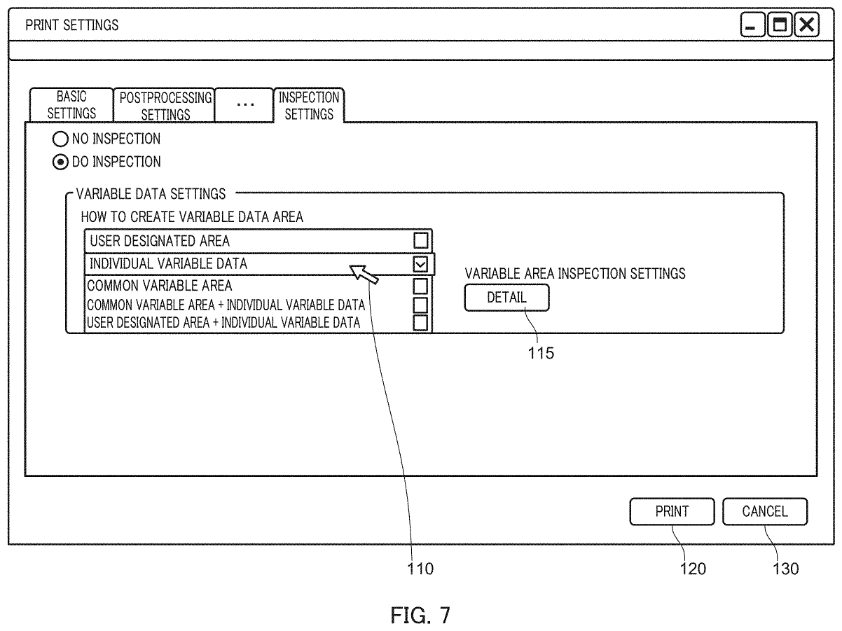

FIG. 7 shows the configuration of a setting screen for making the various settings described above. The setting screen (inspection setting screen) shown in FIG. 7 is a part of the printing setting screen displayed on the display of PC 60 prior to the execution of the print job for printing the input image data including variable data.

In particular, in image quality inspection system 1 of this embodiment, to print input image data including variable data, the tab “Inspection settings” is added as a selection tab selectable with mouse pointer 110. When the “Basic settings” tab is selected, a basic setting screen for making basic settings for printing, such as the number of sheets or copies and selection of color print, is displayed. When the “Postprocessing settings” tab is selected, the sorting destination (paper discharge tray 42 or 43) of printed sheet S can be set. Subsequently, when the “Inspection settings” tab is selected, the inspection setting screen shown in FIG. 7 is displayed.

In this inspection setting screen, prior to the execution of the print job, execution/no execution of the quality check job (image quality inspection) described above, that is, “inspect” or “do not inspect” can be selected. In this regard, in the state shown in FIG. 7, “inspect”, that is, the execution of the quality check job is selected, and the following description will be made on the assumption that the quality check job is executed.

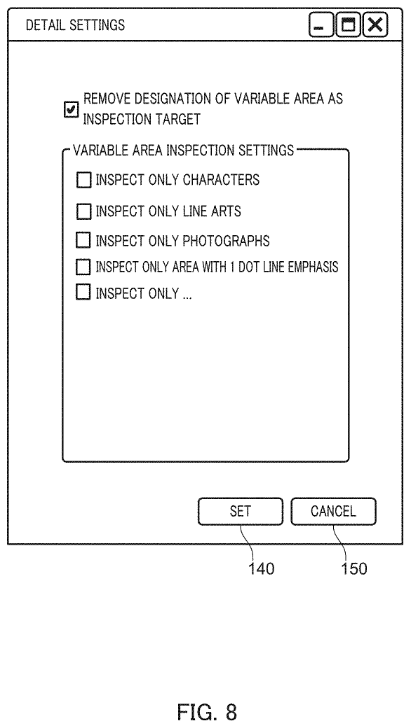

Selecting “Detail” button 115 displayed on the inspection setting screen shown in FIG. 7 displays the detail setting screen shown in FIG. 8. Variable image VI can also be included in the inspection target in the quality check job by removing the check of “Remove variable area from inspection target” (default state) on the detail setting screen. However, the following description will be made on the assumption that the default setting of “Remove variable area from inspection target” is maintained.

On the inspection setting screen shown in FIG. 7, in order to define an inspection target area on sheet S in the inspection job, a “Variable data settings” field is displayed prior to the execution of the print job and the quality check job. In the “Variable data settings” field, the user can select a method for rewriting or resetting the variable data area, that is, newly defining the variable data area. In the example shown in FIG. 7, any one of the following can be selected: “User designated area”, “Individual variable data”, “Common variable area”, “Common variable area+individual variable data”, and “User designated area+individual variable data” as options of the method.

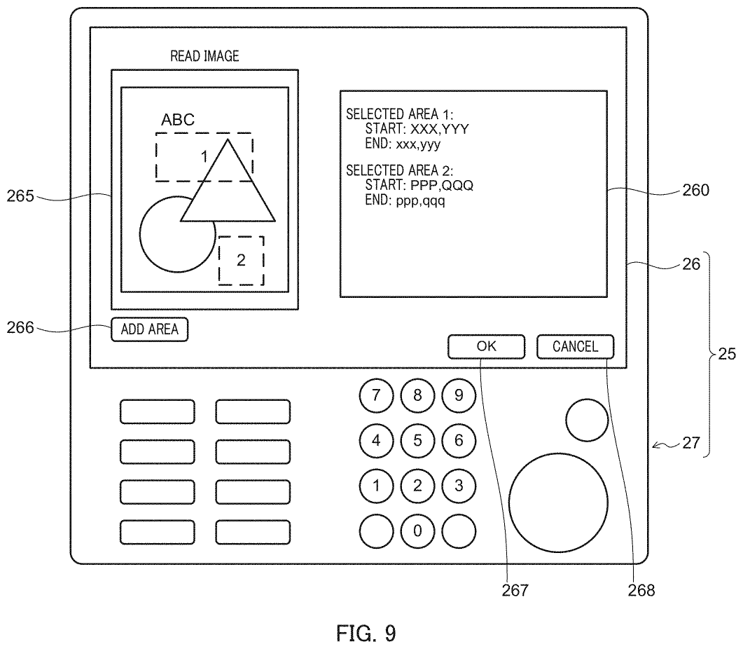

At this time, when “User designated area” is selected by the user, quality inspection apparatus 50 displays the setting screen shown in FIG. 9, and the area designated (operationally selected) by the user through the setting screen is set as a variable data area in the quality check job (in this example, the area excluded from the inspection target; the same applies hereinafter).

In this case, quality inspection apparatus 50 creates and registers a correct image (inspection image) from which the area designated by the user is excluded and in which the arrangement of the pixels (see FIG. 4) of common image CI in the page data is held, in Step S160 in FIG. 5.

Such selection and setting are advantageous, for example, when the position of variable image VI to be printed on sheet S is known in advance and common image CI is additionally printed on, for example, sheet S on which variable image VI (destination information and the like) has already been printed. The description of the setting screen shown in FIG. 9 will be described later.

In addition, when “Individual variable data” is selected, quality inspection apparatus 50 sets each variable image VI described above with reference to FIG. 4 (for example, in the case of PDF-VT, pixel attribute information defined for the PDF file for variable data) is set as a variable data area in the quality check job. To be specific, quality inspection apparatus 50 generates a virtual image in which individual variable images VI for pages to be subject to the print job are superimposed, and the superimposed images are set as a variable area (the area to be an exception to the image quality inspection) in the quality check job.

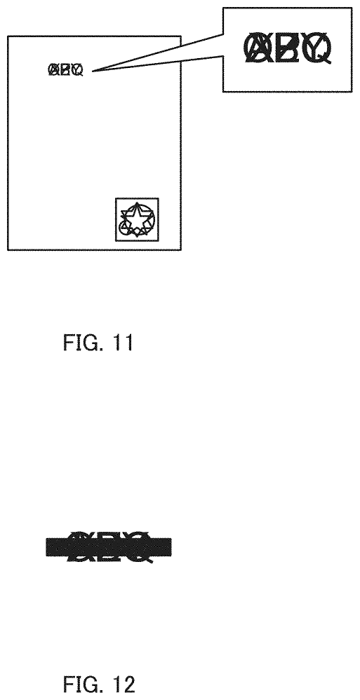

Here, FIG. 11 is a diagram showing a form in which variable images VI (character portion and graphic portion) in the pages shown in FIGS. 10A to 10C are superimposed, and the enlarged view of the character portions (that is, “ABC”, “OPQ”, and “XYZ”) is shown on the right.

In this case, in Step S160 of FIG. 5, quality inspection apparatus 50 creates and registers a correct image (inspection image) in which the arrangement of the pixels of common image CI in the page data (see FIG. 4) is held and from which the pixels in the overlap between variable images VI shown in FIG. 11 are excluded.

Such selection and setting can be advantageously used in various cases when the area on sheet S to be inspected in the quality check job should be ensured as wide as possible. To be specific, as described above, when common variable area CVA is wider than variable image VI (see FIG. 4), or when common variable area CVA is set to straddle or overlap common image CI, the area of the margin, for example, in common variable area CVA can be added to the target of the image quality inspection. Such selection and setting can also be applied in the case where variable image VI is set to extend out of common variable area CVA (see FIG. 10A, for example). For this reason, in this embodiment, the selection and setting of “Individual variable data” is in the default state.

When “Common variable area” is selected, quality inspection apparatus 50 sets common variable area CVA described above with reference to FIG. 4 (for example, in the case of PDF-VT, the area defined for the PDF file for variable data) as a variable data area in the quality check job.

In this case, in Step S160 of FIG. 5, quality inspection apparatus 50 creates and registers a correct image (inspection image) in which the arrangement of the pixels of common image CI in the page data (see FIG. 4) is held and from which common variable area CVA is excluded.

Such selection and setting are advantageous in reducing the weight of processing such as correct image generation in the case where the outer shape (rectangular frame portion) of variable image VI in each page matches common variable area CVA as it is printed in the lower right side of each sheet S in FIGS. 10A to 10C.

When “Common variable area+individual variable data” is selected, quality inspection apparatus 50 generates a virtual image in which the two types described above, that is, variable image VI and common variable area CVA for each page are superimposed. Subsequently, quality inspection apparatus 50 sets the image obtained by the superimposition as a variable area in the quality check job (that is, an area excluded from the inspection target). Here, FIG. 12 is a diagram showing the state where the common variable areas (attribute) and individual variable pixel information in the character portions shown in FIGS. 10A to 10C are superimposed.

In this case, in Step S160 of FIG. 5, quality inspection apparatus 50 creates and registers a correct image (second correct image) in which the arrangement of the pixels of common image CI (see FIG. 4) is held and from which the pixels in the overlap between variable images VI shown in FIG. 12 and the portion of common variable area CVA are excluded.

Such selection and setting are advantageous in reducing the resource load of the processor during the execution of the quality check job. In particular, with the default setting of “Individual variable data”, the area on sheet S to be inspected in the quality check job is maximized, and the area of the gaps around the characters and graphics in the variable image obtained by the superimposition (see FIG. 11) are also to be subject to image quality inspection. In contrast, with this selection and setting, all or most of the area of the gaps is excluded from the target of the image quality inspection, thereby reducing the resource load of the processor during the execution of the quality check job.

On the other hand, as explained with reference to FIG. 4, with such selection and setting, the problem arises that the area to be inspected is small when common variable area CVA is wider than variable image VI. For this reason, when “Common variable area+individual variable data” is selected, only when variable image VI defined in the input image data extends out of the corresponding common variable area CVA, quality inspection apparatus 50 excludes both portions from the inspection target.

When “User designated area+individual variable data” is selected, quality inspection apparatus 50 generates a virtual image in which variable images VI and the areas designated by the user for the pages are superimposed, and sets the image as a variable area in the quality check job (in this example, an area not to be subject to the image quality inspection).

In this case, in Step S160 of FIG. 5, quality inspection apparatus 50 creates and registers a correct image (inspection image) in which the arrangement of the pixels of common image CI in the page data (see FIG. 4) is held and from which the pixels in the overlap between variable images VI shown in FIG. 11 and the area designated by the user are excluded.

As in the case of “Common variable area+individual variable data”, such selection and setting are advantageous in reducing the resource load of the processor during the execution of the quality check job. For example, in the example case shown in FIG. 12 in setting “Common variable area+individual variable data”, a part (outer part) of the area of the gaps around the characters in the variable image obtained by the superimposition can also be regarded as the target of the image quality inspection. In contrast, in setting “User designated area+individual variable data”, when the user designated area is set to surround each character in the variable image, a part of the area of the gaps can also be excluded from the target of the image quality inspection.

Note that these selections can be canceled as appropriate by selecting “Cancel” button 130.

FIG. 9 shows an example of a setting screen (hereinafter referred to as a “variable area setting screen”) for setting the “User designated area” described above. In the example shown in FIG. 9, it is assumed that the variable area setting screen is displayed on operation display section 25 (display section 26) of image forming apparatus 20.

Alternatively, the variable area setting screen may be displayed on the display of PC 60.

The variable area setting screen shown in FIG. 9 is displayed when “Print” button 120 is selected in the state where “User designated area” or “User designated area+individual variable data” is selected on the variable data setting screen (the screen of the inspection setting tab) shown in FIG. 7.

To be specific, selecting “Print” button 120 transmits data set by the user on the screens shown in FIGS. 7 and 8 described above, and the input image data (print data) including variable image data from PC 60 to image forming apparatus 20.

Upon reception of this data, if any item other than “User designated area” or “User designated area+individual variable data” is being selected through user setting, image forming apparatus 20 causes quality inspection apparatus 50 to create and register a correct image (inspection image) according to the selected item, and starts a print job. Note that the correct image (inspection image) created and registered here is an image from which variable image VI (see FIG. 4) is excluded according to the above selected item.

To be specific, quality inspection apparatus 50 performs the processing of Step S110 to Step S150 shown in FIG. 5 in the same manner as described above. On the other hand, in Step S160, quality inspection apparatus 50 creates and registers a correct image (inspection image) in which information on the arrangement of the pixels of common image CI in the page data (see FIG. 4) is held and from which the pixels of variable image VI are excluded according to the above-described selected item.

On the other hand, when any item other than “User designated area” or “User designated area+individual variable data” is selected through user setting, image forming apparatus 20 displays the variable area setting screen shown is FIG. 9 as a correct image registration screen on display section 26 in Step S150 shown in FIG. 5.

In the example shown in FIG. 9, read image display section 265 and “Add area” button 266 are displayed on the left side of the display screen of display section 26, and selected area display section 260 is displayed on the right side of the display screen.

At the time, read image display section 265 displays the read image of the printed material on the first page (sheet S on which the image is formed) printed and scanned in Step S130 shown in FIG. 5. Selecting “Add area” button 266 in that display state displays the rectangular selected areas indicated by the dashed lines in FIG. 9 in read image display section 265. FIG. 9 shows the case where “Add area” button 266 is selected twice and two selected areas (selected area 1 and selected area 2) are displayed in read image display section 265.

The position and size of these selected areas (1 and 2) can be arbitrarily changed by, for example, touch operation on the touch screen or mouse operation. In addition, the position of “Start” (for example, the coordinates of the upper left corner of the selected area) and the position of “End” (the coordinates of the lower right corner of the same) in the area where that operation is performed are displayed on selected area display section 260 (see FIG. 9). In addition, the position and the like of the selected area displayed in read image display section 265 can be changed by inputting or changing the position coordinates displayed on selected area display section 260 by an operational input through operation section 27 (for example, a numeric key pad or a cursor) of operation display section 25.

Selecting “OK” button 267 is selected after the number of selected areas, their positions, and the like are determined through the user's operation described above establishes settings for the selected areas and saves information on the settings in the memory. In contrast, selecting “Cancel” button 268 sequentially cancels the settings for selected area 2, the settings for selected area 1, and even the content displayed in FIG. 9, according to the number of selections.

In the example shown in FIG. 9, the selected areas (1 and 2) are set to be rectangular frames.

Alternatively, the selected areas may be set to be free-form frames, for example, by tracing the surface of the touch screen displaying read image display section 265 with a touch pen or the like.

Thus, in the quality check job (Step S340 in FIG. 6) executed after the above-described various settings are made, quality inspection apparatus 50 compares the read image related to the variable printed material generated by image reading apparatus 30 with the correct image (inspection image) set and registered through the setting screen shown in FIG. 7 and the like to extract a difference, thereby inspecting the presence or absence of an image failure. In other words, quality inspection apparatus 50 determines the images or areas set by the user to be variable areas, and excludes the images or areas from the target of the comparison processing of Step S340.

According to this embodiment that involves such processing, the number of correct images to be created (registered) can be minimized according to the settings for variable image VI and the mode of printing, so that the target of image quality inspection can include an area other than variable image VI, which area is set as wide as possible or appropriate for the user's purpose.

In the configuration example described above, quality inspection apparatus 50 creates and registers a correct image (inspection image) according to the content (item) selected through the setting screen described with reference to FIG. 7 and the like (Step S160 shown in FIG. 5), and performs comparison with the correct image, thereby inspecting the presence or absence of an image failure in the area other than variable image VI.

Alternatively, quality inspection apparatus 50 may directly register the image of the variable printed material on the first page read by image reading apparatus 30 as the second correct image (Step S160). In this case, quality inspection apparatus 50 may rewrite the second correct image according to the content (item) selected through the setting screen described in FIG. 7 and the like in the processing routine shown in FIG. 6 described above (for example, Step S310). Alternatively, if an area to be compared in Step S340 is determined to be a variable area (an area not to be inspected) according to the content (item) selected through the setting screen described with reference to FIG. 7 (YES in Step S330), quality inspection apparatus 50 may simply skip comparison of the area with the correct image (the inspection image).

The case where variable image VI is subjected to image quality inspection will now be described.

In one example, when variable data (printed variable image VI) is a target of inspection in the quality check job, quality inspection apparatus 50 creates a correct image (that is, a third correct image) of variable data (printed variable image VI) for each print page, by using raster image processor (RIP) image data obtained before printing.

As described above, variable data (printed variable image VI) can be divided into the object for which the acceptable level may be set relatively low in the inspection of the image quality (for example, an address and name), and the object for which the acceptable level may be set high. Here, examples of the object of variable data for which the acceptable level should be set high include identification information, such as ID numbers and barcodes, and photographs.

Therefore, in this embodiment, quality inspection apparatus 50 can determine whether each type of variable data object is regarded as an image quality inspection target, based on the attribute information on the variable image defined (set) for the input image data.

To be specific, in this embodiment, selecting “Detail” button in the variable data setting field on the screen shown in FIG. 7 displays the variable area detail setting screen shown in FIG. 8. Here, it is possible to select whether or not the variable area selected (or defined) in the “variable data setting” field shown in FIG. 7 is to be excluded from the inspection target in the quality check job, and that variable area is set to be removed from the inspection target in the default state.

In contrast, selecting the mode in which the variable area selected in the “Variable data settings” field shown in FIG. 8 is not to be excluded from the inspection target in the quality check job (that is, removing the designation of the variable area as an exception to inspection) enables selection of the “Variable area inspection settings” field as an additional inspection target. In the “Variable area inspection settings” field, whether or not it is to be an image quality inspection target can be set depending on each type of variable data object. To be specific, the user can determine whether or not it is to be an image quality inspection target depending on the type of object of variable data defined in the print data, such as “Inspect only characters”, “Inspect only line arts, “Inspect only photographs”, or “Inspect only area with 1 Dot Line Emphasis”. Note that “Inspect only thin line areas” may be selected as a subordinate item of “Inspect only line arts”. Further, “Inspect only portraits” may be selected as a subordinate item of “Inspect only photographs”.

In addition, as an additional configuration of the “Variable area inspection settings” field, whether or not it is to be an image quality inspection target may be determined depending on the color parameter of the object of variable data. For example, “Inspect only the area of the color designated by the user”, “Inspect only the area of pure black (area printed with 100% black toner)”, “Inspect only the area with gray replacement (area printed with 100% black toner), “Inspect only the area of alternative color”, “Inspect only the area of special color”, and the like may be given as options.

Thus, selecting “Set” button 140 after a selective input operation (checking a check box in this example) is performed in the “Variable data settings” field, establishes settings through the screens shown in FIGS. 7 and 8, and returns the screen to that shown in FIG. 7. In contrast, selecting “Cancel” button 150 on the screen of FIG. 8 cancels the settings on the screen shown in FIG. 8 and returns the screen to that shown in FIG. 7.

When variable data (printed variable image VI) is a target of inspection in the quality check job, quality inspection apparatus 50 creates a correct image (corresponding to an “individual inspection image”) of variable data (variable image VI to be printed) for each print page, by specifying the area according to the item set in the “Variable data settings” field. Such processing is performed separately from the processing routine described above with reference to FIG. 5.

Further, when variable data (printed variable image VI) is to be inspected in the quality check job and it is determined that the designated pixel is in common variable area CVA in above-described Step S330 shown in FIG. 6 (YES in Step S330), quality inspection apparatus 50 performs the following processing. By comparison of one area including that pixel with the area in the correct image of variable data created as described above, quality inspection apparatus 50 inspects the quality (presence or absence of a defective image) of the image in that area, and the process proceeds to Step S360.

As described above, creating correct data using the RIP image before printing has a problem in that a deviation from the acceptable level required by the user is likely to occur. For this reason, in this embodiment, when variable data (printed variable image VI) is to be inspected in the quality check job, inspection is performed with criteria laxer than those for inspection of the image quality (presence or absence of a defective image) of common image CI (see Step S340, for example). In one specific example, it is preferable that the user can set an error range from a correct image for detecting printed variable image VI as a defective image in the “Variable area inspection settings” field described above with reference to FIG. 8.

On the other hand, for example, when “Inspect only the area of pure black” or “Inspect only the area with gray replacement” is selected among the various settings described above, quality inspection apparatus 50 preferably inspects the degree of coincidence with the correct image according to criteria similar to the criteria of the inspection (see Step S340, for example) of the image quality (the presence or absence of a defective image) of common image CI. Similarly, when “Inspect only portraits” is selected, quality inspection apparatus 50 preferably inspects the degree of coincidence with the correct image according to criteria similar to the criteria of the inspection (see Step S340, for example) of the image quality (the presence or absence of a defective image) of common image CI.

In addition, when “Inspect only thin line areas” is selected, quality inspection apparatus 50 preferably strictly inspects the presence or absence of foreign matters (such as dust and contamination) around the thin line area. When “Inspect only the area with 1 Dot Line Emphasis” is selected, quality inspection apparatus 50 preferably strictly inspects the presence/absence of line dropouts in the emphasized portion.

As described above, in this embodiment, when the designation of the variable area as an exception to inspection is removed, quality inspection apparatus 50 generates a correct image (individual inspection image) related to a variable area for each print page, based on attribute information on the variable image set for the input image data, and inspects the variable area according to the inspection conditions designated by the user and based on the difference between the read image and the individual inspection image. With this configuration, even for printing a variable printed material and performing image inspection for a large number of sheets, for example, several thousand pages, the number of correct images created using the actual printed material can be minimized.

As described above in detail, in this embodiment, for printing a variable printed material including both common image (CI) and variable image (VI) on multiple pages, quality inspection apparatus 50 inspects the presence or absence of an image failure, excluding the area designated by the user as an exception to inspection and based on the difference between the read image (second read image) by image reading apparatus 30 and the correct image (inspection image).

In addition, in this embodiment, for printing a variable printed material including both a common image and a variable image on multiple pages, quality inspection apparatus 50 separately registers a correct image for common image (CI) and a correct image for variable image (VI) (individual inspection image) and inspects them according to different criteria.

In this embodiment with such a configuration, it is possible to perform image quality inspection in which the number of correct images created using the actual printed material is reduced and a deviation from the acceptable level required by the user is suppressed.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image inspection system, comprising:
an image former that forms an image on a sheet based on image data in which a common area and a variable area set therein, the common area being an area in which a same image is printed on a plurality of print pages, the variable area being an area in which a variable image that differs between the plurality of print pages is printed;
an image reader that generates a read image by reading the formed image;
a hardware processor that generates an inspection image used to perform image inspection, based on a first read image generated; and
a hardware processor that inspects a second read image generated, based on a difference between the second read image generated and the inspection image, excluding an area designated by a user as an exception to inspection.

2. The image inspection system according to claim 1, wherein the hardware processor performs the inspection on an area excluding both the variable image and an area selected by the user.

3. The image inspection system according to claim 1, wherein the hardware processor performs the inspection on an area excluding both the variable image and the variable area.

4. The image inspection system according to claim 1, wherein the hardware processor performs the inspection on an inspection target including a portion other than the variable image in the variable area set in the image data.

5. The image inspection system according to claim 4, wherein the hardware processor performs the inspection on an inspection target including the portion other than the variable image for all pages set in the image data.

6. The image inspection system according to claim 1, wherein the hardware processor performs the inspection on an area excluding both the variable image and the variable area for all pages set in the image data.

7. The image inspection system according to claim 3, wherein, in a case where the variable image set in the image data extends out of the corresponding variable area, the hardware processor performs the inspection on an area excluding both the variable image and the variable area.

8. The image inspection system according to claim 1, wherein the area to be an exception to inspection is selectable from the following: both the variable image and a region selected by the user; both the variable image and the variable area; both the variable image and the variable area for all pages set in the image data; and both the variable image and the variable area in a case where the variable image set in the image data extends out of the corresponding variable area.

9. The image inspection system according to claim 1, wherein
the hardware processor generates, for each print page, an individual inspection image related to the area to be an exception to inspection, based on attribute information on the variable image set in the image data, and
when the designation of the area as an exception to inspection is removed, the hardware processor inspects the area, according to an inspection condition designated by the user and based on a difference between the second read image and the individual inspection image.

10. An image inspection method, comprising:
forming an image on a sheet based on image data including a common area and a variable area set therein, the common area being an area in which a same image is printed on a plurality of print pages, the variable area being an area in which a variable image that differs between the plurality of print pages is printed;
generating a read image by reading the formed image;
generating an inspection image used to perform image inspection, based on a first read image generated; and
inspecting a second read image generated, based on a difference between the second read image generated and the inspection image, excluding the area designated by a user as an exception to inspection.

11. A non-transitory computer-readable recording medium that stores an image inspection program, the program causing a computer to perform processing comprising:
forming an image on a sheet based on image data including a common area and a variable area set therein, the common area being an area in which a same image is printed on a plurality of print pages, the variable area being an area in which a variable image that differs between the plurality of print pages is printed;
generating a read image by reading the formed image;
generating an inspection image used to perform image inspection, based on a first read image generated; and
inspecting a second read image generated, based on a difference between the second read image generated and the inspection image, excluding the area designated by a user as an exception to inspection.
